(19) United States
(12) Patent Application Publication
(10) Pub. No.: US 2019/0152553 A1
(43) Pub. Date: May 23, 2019

(54) RECUMBENT BICYCLE

(71) Applicant: Timothy Daniel, Hampton, VA (US)

(72) Inventor: Timothy Daniel, Hampton, VA (US)

(21) Appl. No.: 15/820,410

(22) Filed: Nov. 21, 2017

(51) Int. Cl. B62K 3/00; B62K 21/12; B62K 3/02; B62J 1/18; B62L 5/00; B62K 21/02; B62J 1/28; B62J 11/00; B62M 1/36; B62M 9/00; B62H 1/04; B62J 7/06

(52) U.S. Cl. CPC B62K 3/005; B62K 21/12; B62K 3/02; B62J 1/18; B62L 5/00; B62J 7/06; B62J 1/28; B62J 11/00; B62M 1/36; B62M 9/00; B62H 1/04; B62K 21/02

(57) ABSTRACT

A recumbent bicycle for recumbent riding includes a frame that is tubular and elongated. A handlebar, which is ape hanger-styled, is rotationally coupled to a front of the frame. A first wheel and a second wheel are rotationally coupled to a rear of the frame and the handlebar, respectively. A seat is coupled to a top of the frame. A sprocket, which is coupled to the frame proximate to the front, is operationally coupled to the first wheel. A pair of pedals is coupled to and extends from the sprocket. Each pedal is configured to position a respective foot of the user so that the user is positioned to compel rotation of the sprocket concurrent with the pedals. The sprocket is positioned to compel rotation of the first wheel to locomote the frame and the user. The pedals also are configured to be reversibly rotated to brake the first wheel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to bicycles and more particularly pertains to a new bicycle for recumbent riding.

### BRIEF SUMMARY OF THE INVENTION

An embodiment of the disclosure meets the needs presented above by generally comprising a frame that is tubular and elongated. A handlebar, which is ape hanger-styled, is rotationally coupled to a front of the frame. A first wheel and a second wheel are rotationally coupled to a rear of the frame and the handlebar, respectively. A seat is coupled to a top of the frame. A sprocket, which is coupled to the frame proximate to the front, is operationally coupled to the first wheel. A pair of pedals is coupled to and extends from the sprocket. Each pedal is configured to position a respective foot of the user so that the user is positioned to compel rotation of the sprocket concurrent with the pedals. The sprocket is positioned to compel rotation of the first wheel to locomote the frame and the user. The pedals also are configured to be reversibly rotated to brake the first wheel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a recumbent bicycle according to an embodiment of the disclosure.

FIG. 2 is a front view of an embodiment of the disclosure.

FIG. 3 is a rear view of an embodiment of the disclosure.

FIG. 4 is a bottom view of an embodiment of the disclosure.

### DETAILED DESCRIPTION OF THE INVENTION

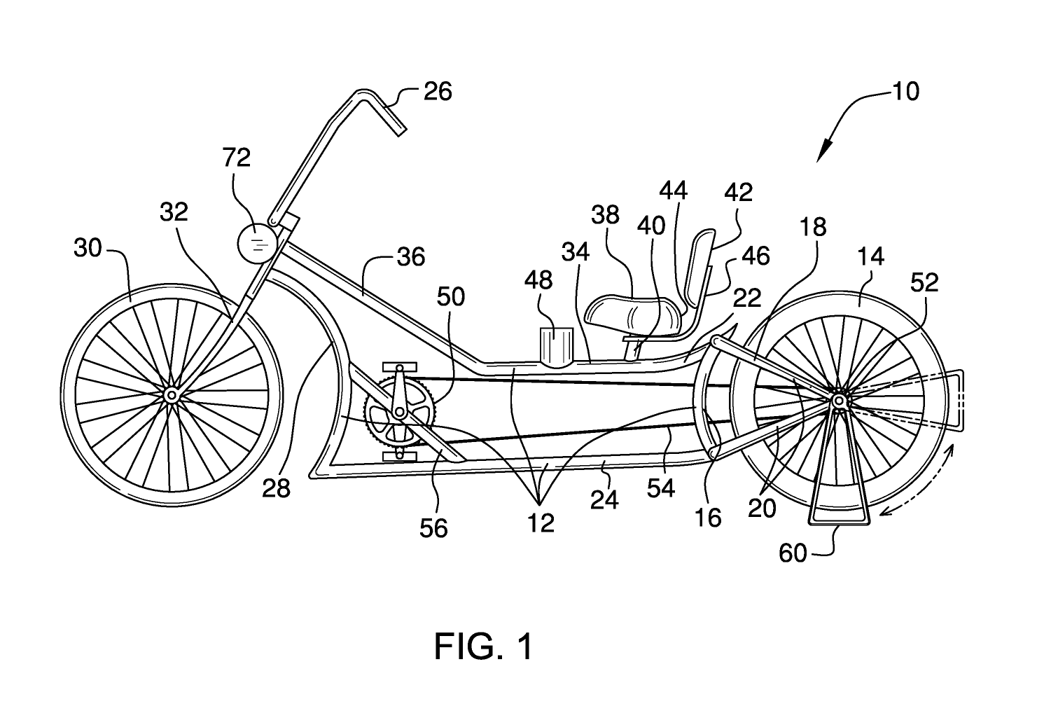

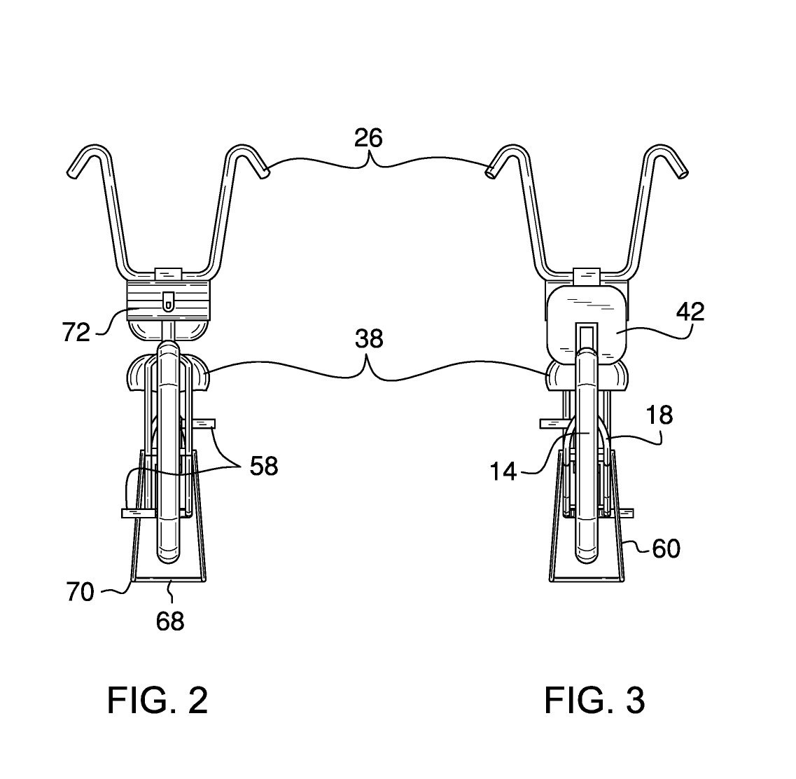

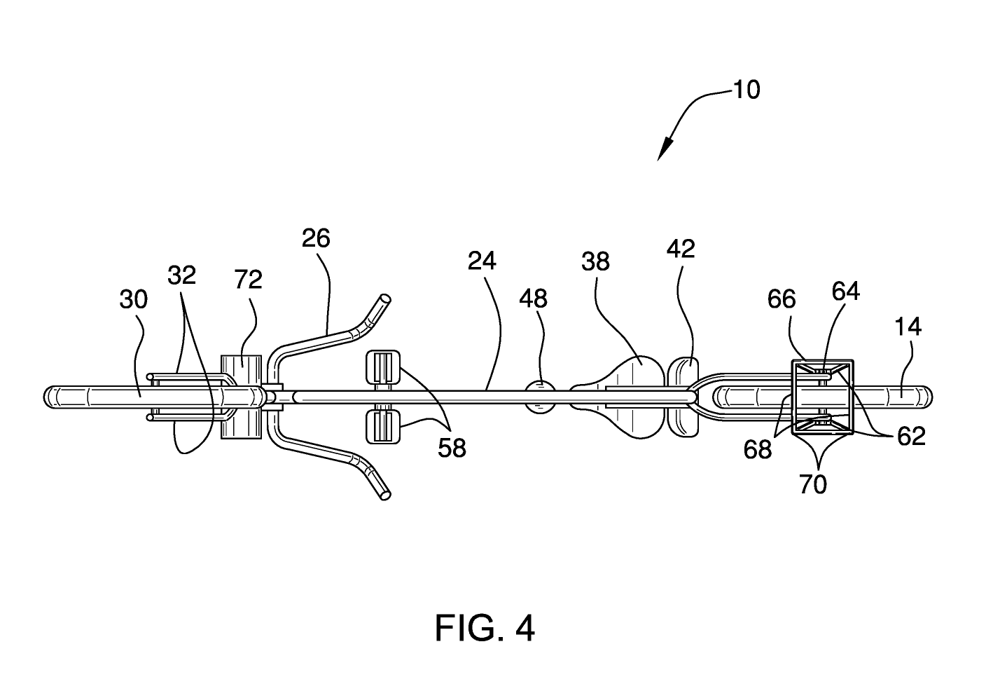

With reference now to the drawings, and in particular to FIGS. 1 through 4 thereof, a new bicycle embodying the principles and concepts of an embodiment of the disclosure and generally designated by the reference numeral 10 will be described.

As best illustrated in FIGS. 1 through 4, the recumbent bicycle 10 generally comprises a frame 12 that is tubular and elongated. A first wheel 14 is rotationally coupled to a rear 16 of the frame 12.

At least one first fork 18 is coupled to and extends from the rear 16 of the frame 12. The first wheel 14 is axially coupled to the at least one first fork 18. In one embodiment, each at least one first fork 18 comprises two pairs of first rods 20. Each pair of first rods 20 is coupled distally from the frame 12. Each pair of first rods 20 is coupled singly to a top 22 and a bottom 24 of the frame 12. The pair of first rods 20 and the rear 16 are substantially triangularly shaped. In another embodiment, the rear 16 of the frame 12 is arcuate so that the rear 16 is complementary to the first wheel 14.

A handlebar 26 is rotationally coupled to a front 28 of the frame 12. The handlebar 26 is ape hanger-styled. The handlebar 26 is configured to be grasped in hands of a user. A second wheel 30 is rotationally coupled to the handlebar 26.

A second fork 32 is coupled to and extends from the handlebar 26. The second wheel 30 is axially coupled to the second fork 32. The front 28 of the frame 12 is dimensionally larger than the rear 16 of the frame 12 so that the top 22 comprises a first section 34 and a second section 36. The first section 34 of the top 22 extends from the rear 16 in parallel with the bottom 24. The second section 36 extends transversely between the first section 34 and the front 28 of the frame 12. In one embodiment, the front 28 of the frame 12 is arcuate so that the front 28 is complementary to the second wheel 30.

A seat 38 is coupled to the top 22 of the frame 12. The seat 38 is configured to position buttocks of the user. In one embodiment, the seat 38 is padded. In another embodiment, a post 40 is coupled to and extends between the seat 38 and the frame 12. A panel 42 is coupled to and extends from a back edge 44 of the seat 38. The panel 42 is configured to support a back of the user who is positioned on the seat 38. In yet another embodiment, the panel 42 is arcuate so that the panel 42 is complementary to the back of the user.

A first bar 46 is coupled to and extends between the post 40 and the panel 42. The first bar 46 is substantially L-shaped so that the panel 42 is substantially perpendicular to the seat 38.

A tube 48 is coupled to and extends from the top 22 of the frame 12. The tube 48 is positioned proximate to the seat 38. The tube 48 is configured to insert a container, such as a bottle, to couple the container to the frame 12.

A sprocket 50 is coupled to the frame 12 proximate to the front 28. The sprocket 50 is operationally coupled to the first wheel 14. The sprocket 50 is positioned to compel rotation of the first wheel 14.

A cogwheel 52 is axially coupled to the first wheel 14. A chain 54 is loopedly positioned around the sprocket 50 and the cogwheel 52. The chain 54 is positioned to transfer rotation of the sprocket 50 to the cogwheel 52 to compel rotation of the first wheel 14.

A second bar 56 is coupled to and extends angularly between the front 28 and the bottom 24 of the frame 12. The sprocket 50 is rotationally coupled to the second bar 56.

A pair of pedals 58 is coupled to and extends from the sprocket 50. The pedals 58 are opposingly positioned. Each pedal 58 is configured to position a respective foot of the user. The user is positioned to compel rotation of the sprocket 50 concurrent with the pedals 58 to compel rotation of the first wheel 14 to locomote the frame 12 and the user. The pedals 58 also are configured to be reversibly rotated to brake the first wheel 14.

A kickstand 60 is pivotally coupled to the at least one first fork 18. The kickstand 60 is configured to be selectively extended transversely between the at least one first fork 18 and a surface to support the frame 12 substantially perpendicularly to the surface.

In one embodiment, the kickstand 60 comprises a pair of second rods 62. The second rods 62 are substantially triangularly shaped and defines an apex 64 and a base 66 of the second rod. Each apex 64 is pivotally coupled a respective pair of first rods 20.

A pair of third rods 68 is coupled to and extends between the bases 66 of the second rods 62. Each third rod 68 is positioned proximate to a respective opposing end 70 of the base 66. The pair of third rods 68 and the bases 66 are substantially squarely positioned. The second rods 62 are configured to be selectively pivoted to position the bases 66 between the first wheel 14 and the surface. The first wheel 14 is suspended above the surface to support the frame 12 substantially perpendicularly to the surface.

A bag 72 is coupled to the front 28 of the frame 12 proximate to the handlebar 26. The bag 72 is configured to stow articles of the user. In one embodiment, the bag 72 comprises leather.

In use, the seat 38 is configured to position the buttocks of the user. The panel 42 is configured to support the back of the user who is positioned on the seat 38. The handlebar 26 is configured to be grasped in the hands of the user. Each pedal 58 is configured to position the respective foot of the user. The user is positioned to compel rotation of the sprocket 50 concurrent with the pedals 58. The chain 54 is positioned to transfer rotation of the sprocket 50 to the cogwheel 52 to compel rotation of the first wheel 14 to locomote the frame 12 and the user. The pedals 58 also are configured to be reversibly rotated to brake the first wheel 14. The tube 48 is configured to insert the container, such as the bottle, to couple the container to the frame 12. The bag 72 is configured to stow the articles of the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A recumbent bicycle comprising:
a frame, said frame being tubular, said frame being elongated;
a first wheel rotationally coupled to a rear of said frame;
a handlebar rotationally coupled to a front of said frame, said handlebar being ape hanger-styled;
a second wheel rotationally coupled to said handlebar;
a seat coupled to a top of said frame;
a sprocket coupled to said frame proximate to said front, said sprocket being operationally coupled to said first wheel;
a pair of pedals, each said pedal being coupled to and extending from said sprocket such that said pedals are opposingly positioned; and
wherein said seat is positioned on said frame such that said seat is configured for positioning buttocks of a user, wherein said handlebar is positioned on said frame such that said handlebar is configured for grasping in hands of the user, wherein said sprocket is positioned on said frame such that said sprocket is positioned for compelling rotation of said first wheel, wherein said pedals are positioned on said sprocket such that each said pedal is configured for positioning a respective foot of the user such that the user is positioned for compelling rotation of said sprocket concurrent with said pedals for compelling rotation of said first wheel for locomoting said frame and the user, wherein said pedals are positioned on said sprocket such that said pedals are configured for reversibly rotating for braking said first wheel.

2. The bicycle of claim 1, further comprising:
at least one first fork coupled to and extending from said rear of said frame, said first wheel being axially coupled to said at least one first fork; and
a second fork coupled to and extending from said handlebar, said second wheel being axially coupled to said second fork.

3. The bicycle of claim 2, further including each said at least one first fork comprising two pairs of first rods, each said pair of first rods being coupled distally from said frame, each said pair of first rods being coupled singly to said top and a bottom of said frame such that said pair of first rods and said rear are substantially triangularly shaped, said rear of said frame being arcuate such that said rear is complementary to said first wheel.

4. The bicycle of claim 1, further including said front of said frame being dimensionally larger than said rear of said frame such that said top comprises a first section and a second section, said first section of said top extending from said rear parallelly with said bottom, said second section extending transversely between said first section and said front of said frame, said front of said frame being arcuate such that said front is complementary to said second wheel.

5. The bicycle of claim 1, further including said seat being padded.

6. The bicycle of claim 1, further including a post coupled to and extending between said seat and said frame.

7. The bicycle of claim 6, further including a panel coupled to and extending from a back edge of said seat, wherein said panel is coupled to said seat such that said panel is configured for supporting a back of the user positioned on said seat.

8. The bicycle of claim 7, further including said panel being arcuate such that said panel is complementary to the back of the user.

9. The bicycle of claim 7, further including a first bar coupled to and extending between said post and said panel, said first bar being substantially L-shaped such that said panel is substantially perpendicular to said seat.

10. The bicycle of claim 1, further including a tube coupled to and extending from said top of said frame, said tube being positioned proximate to said seat, wherein said tube is positioned on said frame such that said tube is configured for inserting a container, such as a bottle, for coupling the container to said frame.

11. The bicycle of claim 1, further comprising:
a cogwheel axially coupled to said first wheel;
a chain loopedly positioned around said sprocket and said cogwheel; and
wherein said chain is positioned on said sprocket and said cogwheel such that said chain is positioned for transferring rotation of said sprocket to said cogwheel for compelling rotation of said first wheel.

12. The bicycle of claim 1, further including a second bar coupled to and extending angularly between said front and said bottom of said frame, said sprocket being rotationally coupled to said second bar.

13. The bicycle of claim 3, further including a kickstand pivotally coupled to said at least one first fork, wherein said kickstand is positioned on said at least one first fork such that said kickstand is configured for selectively extending transversely between said at least one first fork and a surface for supporting said frame substantially perpendicularly to the surface.

14. The bicycle of claim 13, further including said kickstand comprising:
a pair of second rods, said second rods being substantially triangularly shaped defining an apex and a base of said second rod, each said apex being pivotally coupled a respective said pair of first rods;
a pair of third rods coupled to and extending between said bases of said second rods, each said third rod being positioned proximate to a respective opposing end of said base such that said pair of third rods and said bases are substantially squarely positioned; and
wherein said second rods are positioned on said pairs of first rods such that said second rods are configured for selectively pivoting for positioning said bases between said first wheel and the surface such that said first wheel is suspended above the surface for supporting said frame substantially perpendicularly to the surface.

15. The bicycle of claim 1, further including a bag coupled to said front of said frame proximate to said handlebar, wherein said bag is positioned on said frame such that said bag is configured for stowing articles of the user.

16. The bicycle of claim 15, further including said bag comprising leather.

17. A recumbent bicycle comprising:
a frame, said frame being tubular, said frame being elongated;
a first wheel rotationally coupled to a rear of said frame;
at least one first fork coupled to and extending from said rear of said frame, said first wheel being axially coupled to said at least one first fork, each said at least one first fork comprising two pairs of first rods, each said pair of first rods being coupled distally from said frame, each said pair of first rods being coupled singly to a top and a bottom of said frame such that said pair of first rods and said rear are substantially triangularly shaped, said rear of said frame being arcuate such that said rear is complementary to said first wheel;
a handlebar rotationally coupled to a front of said frame, said handlebar being ape hanger-styled, wherein said handlebar is positioned on said frame such that said handlebar is configured for grasping in hands of a user;
a second wheel rotationally coupled to said handlebar;
a second fork coupled to and extending from said handlebar, said second wheel being axially coupled to said second fork, said front of said frame being dimensionally larger than said rear of said frame such that said top comprises a first section and a second section, said first section of said top extending from said rear parallelly with said bottom, said second section extending transversely between said first section and said front of said frame, said front of said frame being arcuate such that said front is complementary to said second wheel;
a seat coupled to said top of said frame, wherein said seat is positioned on said frame such that said seat is configured for positioning buttocks of the user, said seat being padded;
a post coupled to and extending between said seat and said frame;
a panel coupled to and extending from a back edge of said seat, wherein said panel is coupled to said seat such that said panel is configured for supporting a back of the user positioned on said seat, said panel being arcuate such that said panel is complementary to the back of the user;
a first bar coupled to and extending between said post and said panel, said first bar being substantially L-shaped such that said panel is substantially perpendicular to said seat;
a tube coupled to and extending from said top of said frame, said tube being positioned proximate to said seat, wherein said tube is positioned on said frame such that said tube is configured for inserting a container, such as a bottle, for coupling the container to said frame;
a sprocket coupled to said frame proximate to said front, said sprocket being operationally coupled to said first wheel, wherein said sprocket is positioned on said frame such that said sprocket is positioned for compelling rotation of said first wheel;
a cogwheel axially coupled to said first wheel;
a chain loopedly positioned around said sprocket and said cogwheel, wherein said chain is positioned on said sprocket and said cogwheel such that said chain is positioned for transferring rotation of said sprocket to said cogwheel for compelling rotation of said first wheel;
a second bar coupled to and extending angularly between said front and said bottom of said frame, said sprocket being rotationally coupled to said second bar;
a pair of pedals, each said pedal being coupled to and extending from said sprocket such that said pedals are opposingly positioned, wherein said pedals are positioned on said sprocket such that each said pedal is configured for positioning a respective foot of the user such that the user is positioned for compelling rotation of said sprocket concurrent with said pedals for compelling rotation of said first wheel for locomoting said frame and the user;
a kickstand pivotally coupled to said at least one first fork, wherein said kickstand is positioned on said at least one first fork such that said kickstand is configured for selectively extending transversely between said at least one first fork and a surface for supporting said frame substantially perpendicularly to the surface, said kickstand comprising:
a pair of second rods, said second rods being substantially triangularly shaped defining an apex and a base of said second rod, each said apex being pivotally coupled a respective said pair of first rods, and
a pair of third rods coupled to and extending between said bases of said second rods, each said third rod being positioned proximate to a respective opposing end of said base such that said pair of third rods and said bases are substantially squarely positioned, wherein said second rods are positioned on said pairs of first rods such that said second rods are configured for selectively pivoting for positioning said bases between said first wheel and the surface such that said first wheel is suspended above the surface for supporting said frame substantially perpendicularly to the surface;
a bag coupled to said front of said frame proximate to said handlebar, wherein said bag is positioned on said frame such that said bag is configured for stowing articles of the user, said bag comprising leather; and
wherein said seat is positioned on said frame such that said seat is configured for positioning the buttocks of the user, wherein said panel is coupled to said seat such that said panel is configured for supporting the back of the user positioned on said seat, wherein said handlebar is positioned on said frame such that said handlebar is configured for grasping in the hands of the user, wherein said sprocket is positioned on said frame such that said sprocket is positioned for compelling rotation of said first wheel, wherein said pedals are positioned on said sprocket such that each said pedal is configured for positioning the respective foot of the user such that the user is positioned for compelling rotation of said sprocket concurrent with said pedals, wherein said chain is positioned on said sprocket and said cogwheel such that said chain is positioned for transferring rotation of said sprocket to said cogwheel for compelling rotation of said first wheel for locomoting said frame and the user, wherein said pedals are positioned on said sprocket such that said pedals are configured for reversibly rotating for braking said first wheel, wherein said tube is positioned on said frame such that said tube is configured for inserting the container, such as the bottle, for coupling the container to said frame, wherein said bag is positioned on said frame such that said bag is configured for stowing the articles of the user.
